(19) United States
(12) Patent Application Publication
(10) Pub. No.: US 2023/0086347 A1
(43) Pub. Date: Mar. 23, 2023

(54) REUSABLE RESPIRATION FILTERING MASK USING A FLUID FILTER WITH PERSISTENT ANTI-MICROBIAL PROPERTIES AND FLUID FILTER WITH PERSISTENT ANTI-MICROBIAL PROPERTIES.

(71) Applicant: Marc P Dowdell, TRENTON, NJ (US)

(72) Inventor: Marc P Dowdell, TRENTON, NJ (US)

(21) Appl. No.: 17/448,044

(22) Filed: Sep. 18, 2021

(51) Int. Cl. A62B 19/00; A01N 59/20; A01N 59/16; A62B 23/02; A62B 18/08; B01D 39/16; B01D 46/00; A41D 13/11

(52) U.S. Cl. CPC A62B 19/00; A01N 59/20; A01N 59/16; A62B 23/025; A62B 18/084; B01D 39/163; B01D 46/0001; A41D 13/11; B01D 2239/083; B01D 2239/0672; B01D 2239/0681; B01D 2239/0613; B01D 2239/0618

(57) ABSTRACT

A respiration filtering face mask that can be washed and sterilized by common means and reused repeatedly comprised of a filtering component that is a laminate of at least one layer of particle filtering material and at least one layer of a microbe killing metallic woven cloth laminated together by adhesive or fusible material in a manner that allows low resistance to air flow, cut to a shape that is folded into a modified cone, a padding filled gasket that is continuously sealed to the outer edge of the filter cone, harness straps that are elastic and user adjustable for length and tension, and an attached shield to prevent fogging of eye ware. A method for making said anti-microbial filter and respiration filtering face mask.

### BACKGROUND

Recently, there has been great interest in different ways to reduce the risk of infection not only in nursing homes, but also in non-healthcare settings such as businesses, offices, schools, and other places where people congregate. The healthcare and non-healthcare environments contain a diverse population of microorganisms, which can cause infection. Microorganisms (e.g., bacteria, fungi, yeast, molds, and viruses) in air and water, on surfaces, on skin, in bodily fluid, and other sources tend to be the biggest players in the spread of infection.

Not only are people at risk of developing serious symptoms of infection, but in some cases becoming unknowing vectors for the spread of serious infections.

Medical knowledge and public awareness of ways in which infections are transmitted is helping to reduce spread of infections. Infection prevention and control procedures involving universal precautions such as hand washing, wearing gloves, filter masks and other protective equipment and has also helped reduced the spread of infections. Unfortunately, when it comes to filler masks, successful acceptance and proper use depends on several factors including efficacy, comfort, usability, wearability, shape-conformance (fit) and durability. Additionally, the reusability of the masks will increase the availability of such masks in the event of pandemics and have a positive impact on the environment by minimizing the number of disposable masks being discarded after a single use. The current generation of respirators/masks is made from non-woven materials and is intended for single use. Moreover, they are not comfortable for the wearer often resulting in nonuse or improper use. Additionally current respiration filtering face masks that filter out microbial pathogens simply hold the microbes but do little to destroy or inactivate them, sometimes causing the mask to be a posable source of infection itself.

Therefore, there is a need for a filter mask which overcomes the problems of conventional filter masks and provides for a comfortable and better fit over a wider range of facial sizes and shapes. Filler masks that help the user properly wear the mask to reduce potential risk of contamination to the wearer and others are still needed.

Respirators are commonly worn over a person's breathing passages for at least one of two common purposes: (1) to prevent impurities or contaminants from entering the wearer's respiratory system; and (2) to protect other persons or things from being exposed to pathogens and other contaminants exhaled by the wearer. A variety of respirators have been designed to meet either (or both) of these purposes. Some respirators have been categorized as being “filtering face-pieces” because the mask body itself functions as the filtering mechanism. Unlike respirators that use rubber or elastomeric mask bodies in conjunction with attachable filter cartridges (see, e.g., ULS. Pat. RIN39,493 to Yuschak et al.) or insert-molded filter elements (see, e.g., U.S. Pat. No. 4,790,306 to Braun), filtering face-piece respirators are designed to have the filter media cover much of the whole mask body so that there is no need for installing or replacing a filler cartridge. These filtering face-piece respirators commonly come in one of two configurations: molded respirators and flat-fold respirators. Molded filtering face piece respirators have regularly comprised non-woven webs of thermally-bonding fibers or open-work plastic meshes to furnish the mask body with its cup-shaped configuration. Molded respirators tend to maintain the same shape during both use and storage. These respirators therefore cannot be folded flat for storage and shipping. examples of patents that disclose molded, filtering, face-piece respirators include U.S. Pat. No. 7,131,442 to Kronzer et al, U.S. Pat. Nos. 6,923,182, 6,041,782 to Angadjivand et al., U.S. Pat. No. 4,807,619 to Dyrud et al., and USS. Pal. No. 4,536,440 to Berg. Flat-fold respirators—as their name implies—can be folded flat for shipping and storage. They also can be opened into a cup-shaped configuration for use. Examples of flat- fold respirators are shown in U.S. Pat. Nos. 6,568,392 and 6,484,722 to Bostock et al., and U.S. Pat. No. 6,394,090 to Chen. Some flat-fold respirators have been designed with weld lines, seams, and folds, to help maintain their cup-shaped configuration during use. Stiffening members also have been incorporated into panels of the mask body (see U.S. Patent Application Publications 2001/0067700 to Dutty et al., 2010/0154805 to Duffy et al., and U.S. Design Pat. 659,821 to Spoo et al.).

It is an object of this disclosure to provide improved respiration filtering masks that provide an improved fit and improved seal to a variety of facial features. It is also an object of this disclosure to provide improved respiration filtering masks that are more comfortable to wear for an extended period of time. It is further an object of this disclosure to provide improved filters and respiration filtering masks that are reusable in whole or in part. It is additionally an object of this disclosure to provide improved respiration filtering masks that can be tailored to fit specific facial features. An object of this disclosure is further to provide methods of making improved filters and respiration filtering masks provided herein.

### Specifications

Various aspects of my respiration filtering mask may have one or more of the following advantages.

My respiration filtering mask can be made with simple equipment in a homemade or cottage industry setting or in an industrial setting with semi-automated to fully automated purpose-built machinery in large scale batch manufacturing or continuous production line manufacturing.

My respiration filtering mask is designed to start actively killing certain viruses and other microbes upon contact or capture by the mask filter, without the use of disinfectants that may adversely affect the user. The microbe killing agent is made of a material that cannot be dislodged or washed out of the mask and will be persistently effective for a long period of time.

My respiration filtering mask is made of materials and designed with assembly methods that allow it to be easily and repeatedly washed using common household methods and machinery (cloths washing machine and dryer) or by hand.

My respiration filtering mask is designed to withstand other means of sterilization (boiling, autoclaving, UV light, and chemical).

My respiration filtering mask is designed to greatly reduce the unfiltered air leakage between the face and the face contacting edges of the respiration filtering mask.

My respiration filtering mask is designed to be comfortable to the user for long periods and through repeated use. To do this it incorporates a number of features. My invention:

Removes sharp edges from contact with the face and Reduces pressure points against the face

Reduces the discomfort of the harness straps.

Allows user to adjust the pressure of the respiration filtering mask against the face.

When not in immediate use the respiration filtering mask can rest on the chest rather than on the neck and chin.

Remains comfortable after repeated washing.

Distributes pressure against a wider area and reduces pressure points against the face.

Has a face gasket made of a comfortable foam filled material that is soft and flexible allowing it to comfortably conform to the shapes of the face.

The face gasket is pressed against not pulled across the surface of the face.

The face gasket more readily conforms to the shape of the bridge of the nose reducing pressure points on the bridge of the nose.

The face gasket more readily shares the bridge of the nose with a pair of glasses.

The face gasket transfers some of the pressure on the bridge of the nose to other areas of the face reducing pressure points.

Directs humid exhalations away from fogging glasses.

Is held away from touching the sensitive parts of the face, such as lips and the lower part of the nose.

Can have the shape adjusted slightly by the user.

Has trans-maxilla curve holders in the face gasket that can be precisely shaped and readjusted by the user and will retain that shape during use.

Has trans-maxilla curve holders that are padded.

Does not deform in response to the pressure differential of exerted breathing.

Directs cool air to the face.

Allows large volume of air flow with a low pressure deferential.

Filter does not clog easily.

Filter works well even in wet conditions.

### BRIEF DESCRIPTION OF THE DRAWINGS

FIG. 1 front view of completed mask on face

FIG. 2 side view of completed mask on face

FIG. 3 side ortho view of completed mask with glasses on face

FIG. 4 side view of completed mask alternate harness position on face

FIG. 5 side view of completed mask

FIG. 6 bottom view of completed mask

FIG. 7 inside view of completed mask

FIG. 8 top view of completed mask

FIG. 9 filter cutting template

FIG. 10 mask filter and harness strap assembly outside face

FIG. 11 mask filter and harness strap assembly inside face

FIG. 12 face gasket pre-form jig

FIG. 13 harness strap fusion strip

FIG. 14 face gasket outer cover

FIG. 15 polyurethane foam member templates

FIG. 16 polyurethane foam member templates variations

FIG. 17 trans-maxilla curve holders

FIG. 18 fog shield

FIG. 19 fog shield cutting template

FIG. 20 face mask on chest

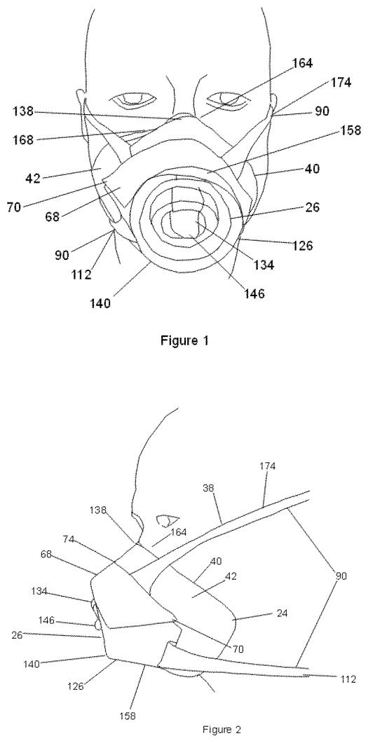

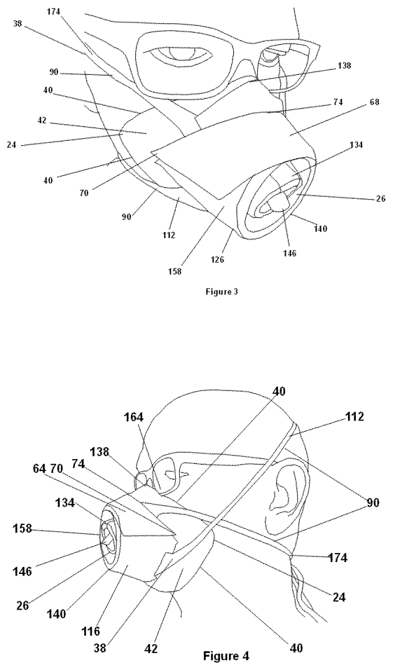

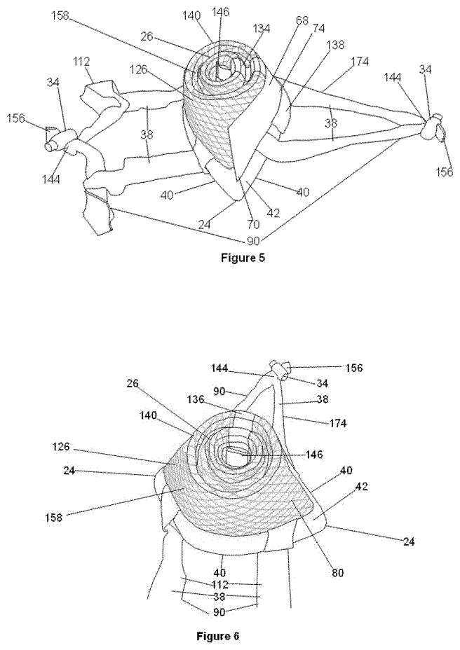

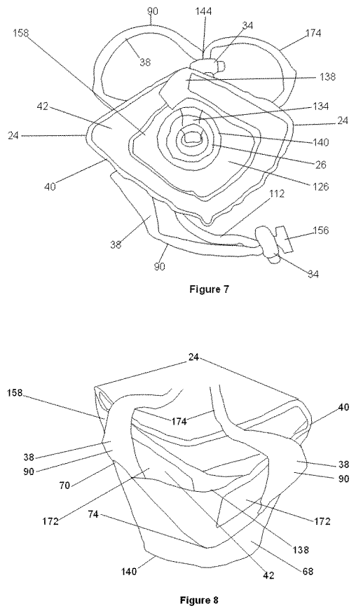

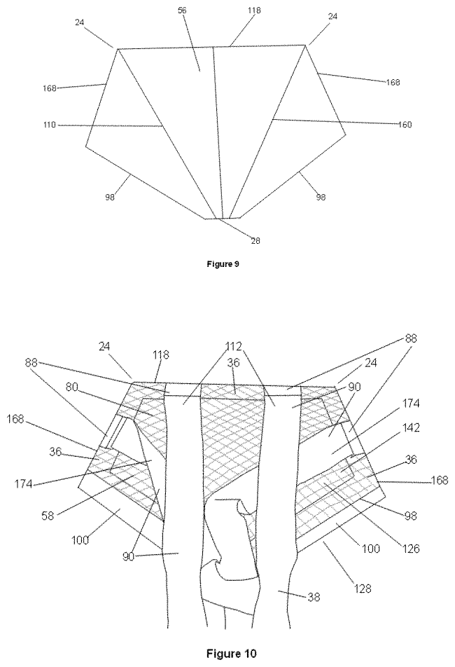

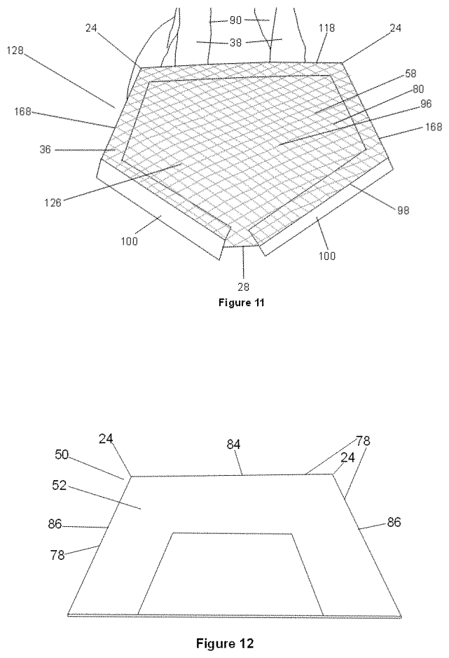

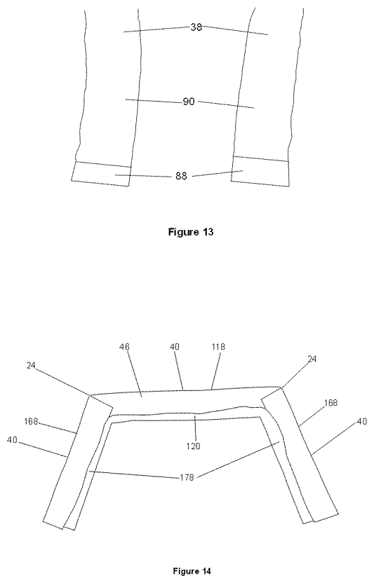

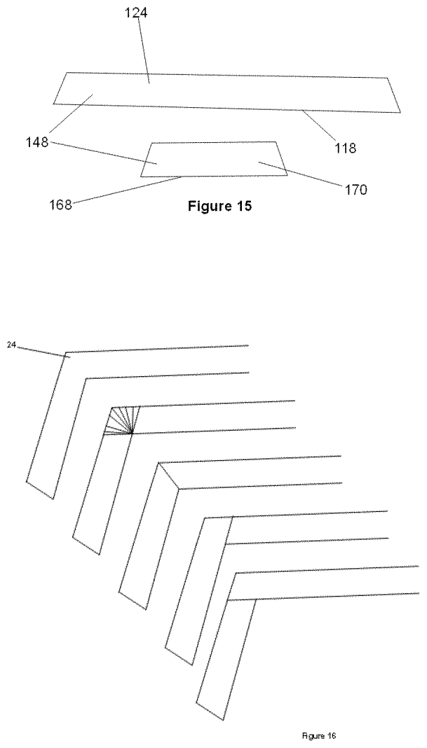

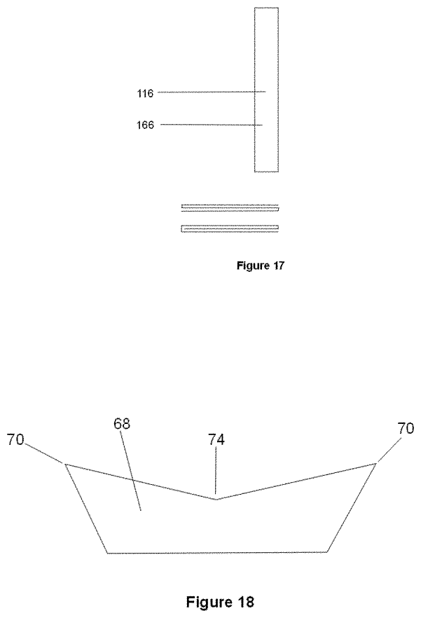

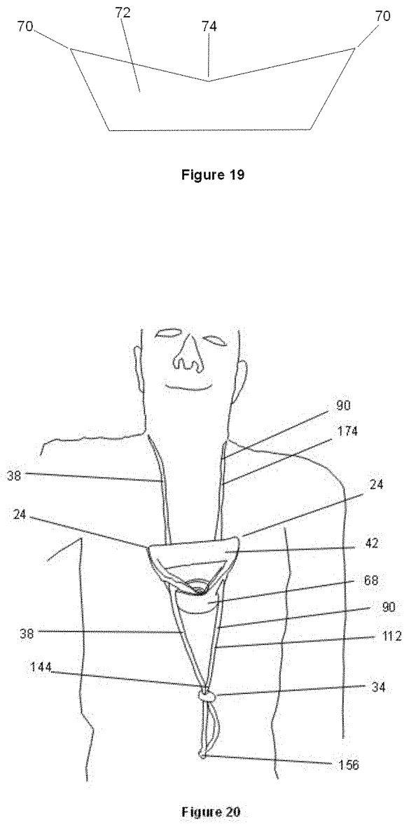

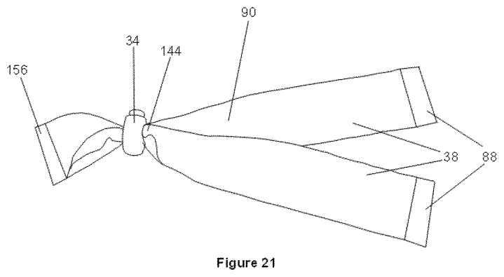

### GLOSSARY

The items set forth below will have the meanings as defined:

Cheek sealing chevron 24: A v in the shape of the outer edge of the cone of the mask filter 126 and the face gasket 42 that will lie over the cheek of the user when the respiration filtering mask 158 is worn.

Concentric pleats 26: Circular folds in the mask filter 126 cone that form pleats in a concentric pattern.

Cone-point-edge 28: A designated line of demarcation on the mask filter 126 and the filter cutting template 56 located between the two ends of the two joining edges 98 opposite the trans-maxilla edge 168 ends. In the finished respiration filtering mask 158 this edge will become the point of the cone.

Copper cloth filter laminate element 30: A web of copper thread cloth 32 with an open web of fusible open mesh 80 laminated to each flat surface of the web.

Copper thread cloth 32: A high thread count woven cloth made of copper or copper alloy threads.

Cord lock mechanism 34: A commercially available device made to be frictionally releasably attached to at least one cord passing through it.

Edge fusion strips 36: Strips of fusible sheet cut 20 millimeters wide and folded in half lengthwise and creased along the fold.

Elastic knit cloth 38: A Knit cloth able to be stretched at least 100% and return essentially to the original dimension without imparting damage to the knit cloth.

Face contacting edges 40: The edges of the respiration filtering mask 158 that come in contact with the face when worn by the user.

Face gasket 42: The part of the respiration filtering face mask 158 that contacts the face of the user and provides the seal between the face and the mask filter 126 of the respiration filtering face mask 158. It is made up of the face gasket outer cover 46, the trans-maxilla curve holders 166, and the polyurethane foam members 150 after the shaping of the face gasket outer cover strip 48 around the face gasket pre-form jig 50 and filling the pockets with the polyurethane foam members 150 and positioning the trans-maxilla curve holders 166 on the polyurethane foam members 150 and fusing to the mask filter and harness strap assembly 128.

Face gasket outer cover 46: The outer layer of the face gasket 42.

Face gasket outer cover strip 48: A strip of a lamination made of one layer of the elastic knit cloth 38 and one layer of the thin film, flexible, and stretchable and fusible web 162 cut to the proper length and width for the face gasket outer cover 46 of the respiration filtering mask 158 being constructed.

Face gasket pre-form jig 50: A device used to shape the face gasket outer cover 46 in preparation for making it into part of the face gasket 42.

Filter cutting template 56: A template of the proper size and shape for a given size of respiration filtering face mask 158 being constructed such that when traced around the edges on to the filter laminate 58 cutting lines will be made for the flat mask filter 126 of the respiration filtering face mask 158 being constructed.

Filter laminate 58: A laminate of filter materials containing at least one layer of filter web as a particle filter and at least one layer of a woven copper thread cloth as a virous killing agent, both layers laminated together in a way that does not impede air flow.

Filter laminate element 60: A web of commercially available filter material or alternately, a lofty nonwoven polyester bat 136 permanently compressed with heat and pressure to form a filter material with an open web of fusible open mesh 80 laminated to each flat surface of the web.

Flat assembly 64: The combination of the mask filter and harness strap assembly 128 and the face gasket 42 fused into a single assembly before the joining of the two joining edges 98 of the mask filter 126.

Fog shield 68: A part of the respiration filtering mask 158 that prevents the passage of air through the mask filter just under the eyes when in use.

Fog shield cheek chevron 70: A convex v shape in the fog shield 68 that will be positioned proximate to a cheek sealing chevron 24 on the respiration filtering mask 158.

Fog shield cutting template 72: A template of the proper size and shape for a given size of respiration filtering face mask 158 being constructed such that when traced around the edges onto the material being used to make the fog shield 68 will produce cutting lines for the desired fog shield 68.

Fog shield nose chevron 74: A concave v shape in the fog shield 68 that will be positioned proximate to the nose bridge chevron overlap 138 on the respiration filtering mask 158.

Forming edges 78: An edge of the face gasket pre-form jig 50 along which the face gasket outer cover strip 48 is folded to form a mandible pocket 120 or one of the trans-maxilla-pockets 178 of the face gasket outer cover 46.

Fusible open mesh 80: A commercially available open mesh of fusible material of a sufficient gage or thickness that when heat pressed into cloth or filter material, some of the fusible material will encompass some of the fibers of the cloth or filter material, or alternately made from commercially available polyethylene bags of the sort used to sell produce and other groceries in.

Fusible sheet 82: A sheet of commercially available fusible material of a sufficient gage or thickness that when melted under pressure a portion of the fusible material will surround surface fibers or threads of the material it is being laminated to.

Gasket mandible forming edge 84: The edge of the face gasket pre-form jig 50 along which the gasket outer cover strip 48 is folded to form the mandible pocket 120 of the face gasket outer cover 46.

Gasket trans-maxilla-forming edges 86: The edges of the face gasket pre-form jig 50 along which the face gasket outer cover strip 48 is folded to form one of the trans-maxilla-pockets 178 of the face gasket outer cover 46.

Harness strap fusion strip 88: An approximately 10 mm wide strip of fusible sheet 82 of a length equal to the width of the harness straps 90 to be fused to the ends of the harness straps 90.

Harness straps 90: Strips of elastic knit cloth 38 attached to the respiration filtering face mask 158 used to secure the respiration filtering face mask 158 to the face when in use.

Heat press 92: A device or machine capable of applying heat and pressure to an item.

Homemade face coverings: Face coverings made by hand for personal use or limited distribution, generally in response to short supply of suitable commercial products.

Inside face 96: A designated face of the mask filter 126 and the mask filter and harness strap assembly 128 that will become the inward facing side of the respiration filtering mask 158 when worn by the user.

Joining edge 98: One of two so designated lines of demarcation on the mask filter, and the filter cutting template 56 located between one end of each of the trans-maxilla edges 168 and one end of the cone-point-edge 28. During the construction of the respiration filtering mask 158 the two joining edges 98 will be joined together allowing the flat respiration filtering mask 66 to be turned into a three dimensional cone.

Joining-edge fusion strips 100: The laminated fusion strips 108 cut to the length of the joining edge 98 of the mask filter 126 of the respiration filtering face mask 158 being constructed.

Laminate elements 104: A filter laminate layer of either a copper cloth filter laminate element 30 or a filter laminate element 60 that when laminated together will form the filter laminate 58.

Laminated fusion strips 108: Strips made from a laminate of the fusible sheet 82 and the elastic knit cloth 38.

Left fold line 110: A line for locating a fold in the Flat assembly 64 that runs from a point near the left cheek sealing chevron 24 to a point approximately one third across the length of and on the left side of the cone-point-edge 28 of the Flat assembly 64.

Low-profile clips 114: Strips of metal folded to provide a pinching member not much thicker than the materials being pinched together, used to hold flat components together in the proper position during the heat press operation.

Lower harness strap 112: The harness strap 90 attached to the lower portion of the respiration filtering face mask 158 and meant to be positioned around the neck when in use.

Malleable strip 116: A strip of malleable, corrosion resistant metal used to make the trans-maxilla curve holders 116.

Mandible edge 118: A designated line of demarcation on the mask filter 126, the filter cutting template 56, and the face gasket 42 located between the two trans-maxilla edges 168 that in the finished respiration filtering mask will be the edge of the mask that transits from cheek to cheek under the mandible or chin of the user.

Mandible pocket 120: A pocket formed in the face gasket outer cover 46 that will receive and hold the mandible polyurethane foam member 122.

Mandible polyurethane foam member 122: A polyurethane foam member 150 of the proper dimensions to fill the mandible pocket 120 of the face gasket outer cover 46.

Mask filter 126: The part of the respiration filtering mask through which all of the inhaled and exhaled respiration is meant to pass.

Mask filter and harness strap assembly 130: An intermediate assembly of parts of the respiration filtering face mask 158 being constructed, comprised of the mask filter 126, edge fusion strips 36, harness straps 90 with the harness strap fusion strips (88), and the joining-edge fusion strips 100 all properly positioned and fused together.

Mask fusion seam 134: A seam made from joining the two joining edges 98 of the mask filter 126 together.

Nonwoven polyester bat 136: A nonwoven polyester padding material used in upholstery, quilting, and apparel, as padding, that can be permanently compressed into a filtering web under the right conditions of heat and pressure.

Nose bridge chevron overlap 138: An overlap of the face gasket outer cover 46 at the v in the shape of the outer edge of the cone of the mask filter 126 and the face gasket 42 that will lie over the bridge of the nose of the user when the respiration filtering mask 158 is worn.

Outer concentric pleat 140: The outermost of a series of circular concentric pleats 26 in the mask filter 126 of the finished respiration filtering mask 158.

Outside face 142: A designated face of the mask filter 126 and the mask filter and harness strap assembly 128 that will become the outward facing side of the respiration filtering mask 158 when worn by the user.

Point of apparent connection 144: A position on a harness strap 90 where the two sides of the harness strap 90 meet, passes through, and are frictionally held together by the cord lock mechanism 34.

Point seal 146: Short strips made from laminated fusion strips 108.

Polyurethane foam member templates 148: Templates of the proper size and shape for a given size of respiration filtering face mask being constructed such that when traced around the edges onto the polyurethane foam sheet cutting lines will be made for the mandible polyurethane foam member 122 and the trans-maxilla polyurethane foam members 172.

Polyurethane foam members 150: Pieces of polyurethane foam shaped to fill the face gasket 42 of the respiration filtering face mask 158.

Release agent sheets: Thermally conductive sheets of material treated or coated to make them non-stick and prevent adhesion to them.

Removal obstruction 156: An obstruction attached in the approximate middle of the length of a harness strap 90 to prevent the removal of the cord lock mechanism 34 from the harness strap 90.

Respiration filtering mask 158: A mask worn on the face enclosing the nose and mouth in a pocket of air separated from air outside the pocket by a filter for the purpose of filtering respiration.

Right fold line 160: A line for locating a fold in the flat assembly 64 that runs from a point near the right cheek sealing chevron 24 to a point approximately one third across the length of and on the right side of the cone-point-edge 28 of the flat assembly 64.

Thin film, flexible, and stretchable and fusible web 162: A web of fusible material similar or equal to commercially available stretch wrap.

Trans-maxilla curve 164: A concave curve in the facial geometry beginning proximate to the bridge of the nose transiting the area over the maxilla frontal process and the infraorbital margin and ending under the eye.

Trans-maxilla curve holders 166: Strips of the malleable strip 116 situated in the face gasket 42 of the respiration filtering mask 158 in a position that will lie on either side of the bridge of the nose and transit the maxilla under the eyes.

Trans-maxilla edge 168: One of two so designated lines of demarcation on the mask filter 126, the filter cutting template 56, and the face gasket 42 located between one end of the mandible edge 118 and one end of one of the joining edges 98. In the finished respiration filtering mask 158 these two trans-maxilla edges 168 will each be the edge of the mask that transits from cheek to the bridge of the nose.

Trans-maxilla-pocket 178: A pocket formed in the face gasket outer cover 46 that will receive and hold one of the trans-maxilla polyurethane foam members 172.

Trans-maxilla polyurethane foam members 172: A polyurethane foam member 150 of the proper dimensions to fill a trans-maxilla-pocket 178 of the face gasket outer cover 46.

Upper harness strap 174: The harness strap 90 attached to the upper portion of the respiration filtering face mask 158 and meant to be positioned around the head when in use.

### Detailed Description of my Respiration Filtering Mask and The Process for Making Same

The Article:

FIG. 2 shows my respiration filtering mask 158 in place on a user's face. The four main components of the respiration filtering mask 158 are a mask filter 126, a face gasket 42, a pair of harness straps 90, and a fog shield 68.

The mask filter 126 material is made of at least one web of filter material and at least one web of a fine woven cloth of copper or copper alloy threads 32, laminated together without restricting air flow through the resulting laminate.

The mask filter 126 is a cone shape, foreshortened using concentric pleats 26 originating at the point of the cone. The open edge of the cone has three angles or chevrons, two cheek chevrons and a nose bridge chevron. The open edge of the mask filter 126 cone is continuously attached to the face gasket 42. The face gasket 42 has two cheek sealing chevrons 24 on opposite sides of the respiration filtering mask 158 pointing away from the mask filter 126, and one nose bridge chevron overlap 138 in the middle of the top of the respiration filtering mask 158 pointing into the mask filter 126. Each end of an upper harness strap 174 is attached to the top half of the mask filter 126 at the edge of the face gasket 42 attachment and approximately midway between each cheek sealing chevron 24 and the nose bridge chevron overlap 138. Each end of a lower harness strap 112 is attached to the lower half of the mask filter 126 at the edge of the face gasket 42 attachment at approximately the same distance from the cheek sealing chevrons 24 as the upper harness strap 174 attachment. The fog shield 68 is laminated to the mask filter 126 and covers an area between the nose bridge chevron overlap 138 and the two cheek sealing chevrons 24 and extends out to the outer concentric pleat 140 of the mask filter 126 cone.

The components of the face gasket 42 are a face gasket outer cover 46 two trans-maxilla curve holders 166 two trans-maxilla polyurethane foam members 172 and a mandible polyurethane foam member 122.

The face gasket outer cover 46 is made of a single layer of the elastic knit cloth 38 and a layer of thin film, flexible, and stretchable and fusible web 162 laminated together. A strip of this face gasket outer cover 46 laminate is folded lengthwise such that the thin film, flexible, and stretchable and fusible web 162 side of the laminate is facing inward and approximately ½ inch or 12 millimeters of the long edge of the folded face gasket outer cover 46 laminate is sealed to the inner and outer face of the edge of the open end of the cone of the mask filter 126. A ¾ inch or 19 millimeter pocket in the face gasket outer cover 46 between the fold and the mask filter 126, is filled with the mandible polyurethane foam member 122 placed between the two cheek sealing chevrons 24 forming the mandible edge 118 of the face gasket 42, and the two trans-maxilla polyurethane foam members 172 each placed between a cheek sealing chevron 24 and the nose bridge chevron overlap 138 forming the two trans-maxilla edges 168 of the face gasket 42. On each trans-maxilla polyurethane foam member 172 a trans-maxilla curve holders 166 is placed parallel to the long direction of the trans-maxilla polyurethane foam member 172 and between the trans-maxilla polyurethane foam member 172 and the outer layer of the face gasket outer cover 46 approximately midway between the two ends of the trans-maxilla polyurethane foam member 172. The two trans-maxilla polyurethane foam members 172 extend from each cheek sealing chevron 24 to within ½ inch or 12 millimeters of the vertex of the nose bridge chevron overlap 138, leaving the pocket of the face gasket outer cover 46 empty and unpadded at the nose bridge chevron overlap 138. At the nose bridge chevron overlap 138 the face gasket outer cover 46 produces an overlap of the face gasket outer cover 46 material as it extends beyond the attachment to the mask filter 126 cone by approximately ¾ inch or 19 millimeters.

The pair of harness straps 90 are made up of the upper harness strap 174 and the lower harness strap 112. Both the upper harness strap 174 and the lower harness strap 112 are made of a strip of elastic knit cloth 38 approximately 1 inch or 25 millimeters wide, with a harness strap fusion strip 88 fused to each side of each end of the strip of elastic knit cloth 38. A cord lock mechanism 34 is installed on each, the upper harness strap 174 and the lower harness strap 112. Each harness strap 90 is folded in approximately the middle of the length of the harness strap 90 and the fold is passed through the hole in the cord lock mechanism 34 so that the harness strap 90 passes through the cord lock mechanism 34 twice. Both the upper harness strap 174 and the lower harness strap 112 have a removal obstruction 156 secured to the strip of elastic knit cloth 38 in approximately the middle of the length of the harness strap 90. The length of the upper harness strap 174 is sufficient to allow the upper harness strap 174 to encircle the head of the user with little tension. The length of the lower harness strap 112 is sufficient to allow the respiration filtering mask 158 to hang at chest level when the respiration filtering mask 158 is not being worn on the face.

The fog shield 68 is laminated to the upper portion of the mask filter 126 cone covering the area between the two cheek sealing chevrons 24 and the outer concentric pleat 140 of the respiration filtering mask 158.

Process of making:

It should be understood that the examples and embodiments described herein are for illustrative purposes only and that various modifications or changes in light thereof will be suggested to persons skilled in the art and are to be included within the spirit and purview of this invention as defined in the appended claims.

The production steps herein describe a hand making process but do not exclude the use of other fully automated, semiautomated or other mechanically assisted assembly methods in single unit, batch, or continuous production methods. The order of the steps may vary.

Filter web material may be obtained commercially, or it may be made by using a lofty nonwoven polyester bat material commercially available intended for padding or the fill of quilting.

The filter web or lofty nonwoven polyester bat material is cut to a width that can fit the manual heat press. This or the filter web material obtained commercially will be referred to as the filter strip 62.

A web of woven copper or copper alloy threads herein referred to as the copper thread cloth 32 is cut to a size that can fit the manual heat press.

A fusible open mesh 80 can be obtained commercially or made from commercially available polyethylene bags of the sort used to sell produce and other groceries in.

A web of a fusible open mesh 80 is cut to the same size as the copper thread cloth 32.

A single layer of the copper thread cloth 32 and a layer of the fusible open mesh 80 or alternately, two layers of the fusible open mesh 80 with a layer of the copper thread cloth 32 sandwiched between are placed into the heat press. The heat press is engaged with the appropriate heat, pressure, and time to cause some of the material of the fusible open mesh 80 to encompass and fuse around some of the threads of the copper thread cloth 32. The cooled result will be referred to as the copper cloth filter laminate element 30.

A sheet of commercially available polyethylene role stock or its equivalent of fusible material of a sufficient gage or thickness that when heat pressed into cloth or filter material, some of the fusible material will encompass some of the fibers of the cloth or filter material, herein this will be referred to as the fusible sheet 82. The fusible sheet 82 role stock is cut into strips approximately 20 millimeters (0.78 inches) wide.

These strips of fusible sheet 82 are folded in half lengthwise and creased along the fold. The resulting folded strips will be referred to as the edge fusion strips 36.

A commercially available paper card stock is used to make a tool for guiding the cutting of the filter laminate 58 into the proper size and shape for the respiration filtering face mask 158 being made. The tool has 6 edges, one mandible edge 118, one cone point edge 28, two trans-maxilla edges 168, and two joining edges 98. The dimensions of these edges and the intervening angles very depending on the size of the respiration filtering mask 158 being constructed. The general shape is to provide a final cone that can be constructed in a flat form and then opened into the cone. The distance between the mandible edge 118 and the cone point edge 28 determines the length of the cone, which can be adjusted to provide adequate filter area and internal volume. The mandible edge 118 and the two trans-maxilla edges 168 will form the open edge of the cone and will determine the circumference size of the respiration filtering face mask 158. The length of the joining edges 98 in relation to the distance between the mandible edge 118 and the cone point edge 28 determines the angle of the nose bridge chevron of the cone which will determine the angle of the nose bridge chevron overlap 138. The resulting tool will be referred to as the filter cutting template 56.

Commercially available aluminum flashing is cut into strips approximately ½ inch (13 millimeters) by 2 inches (50 millimeters). These strips are folded in half to form a pinching clip approximately ½ inch (13 millimeters) wide and 1 inch (50 millimeters) long. The resulting tool will be referred to as the low-profile clips 114.

Commercially available fusible sheet 82 is cut into strips approximately 10 millimeters (0.4 inches) wide. The resulting part will be referred to as the harness strap fusion strip 88.

A web of commercially available knit, woven, or nonwoven material 102 is sandwiched between two webs of fusible sheet 82 and pressed in the heat press with the appropriate heat, pressure, and time to laminate the fusible sheet 82 to both sides of the knit, woven, or nonwoven material 102. The resulting laminate is cut into strips approximately 10 millimeters (0.4 inches) wide and a length equal to the width of the harness strap 90 with which they are intended to be used. The resulting part will be referred to as the removal obstruction 156.

Commercially available copper flashing or equivalent is cut into strips approximately 0.75 inches (20 millimeters) wide. Along the long axis the copper strips are folded in thirds. The resulting part will be referred to as malleable strips 116.

Commercially available 0.25 inch (7 millimeter) loft polyurethane sheet is cut into 0.75 inch (20 millimeter) wide strips. The resulting part will be referred to as a polyurethane foam strip 152.

A commercially available paper card stock is used to make a tool for guiding the cutting of the polyurethane foam strips 152 into the polyurethane foam members 150. The resulting tools will be referred to as polyurethane foam member templates 148. There will be one mandible polyurethane foam member template 124 and one trans-maxilla polyurethane foam member template 170 for each size of respiration filtering mask 158. The shape of the mandible polyurethane foam member template 124 and the trans-maxilla polyurethane foam member template 170 is derived with the use of the filter cutting template 56 for the size respiration filtering mask being constructed.

Using the filter cutting template 56 as a guide, lines are drawn along the trans-maxilla edges 168 and the mandible edge 118 of the filter cutting template 56. Three lines are drawn parallel to the first three lines and 0.75 inches (19 millimeters) (the width of the polyurethane foam strip 152) away from the edges of the filter cutting template 56. These parallel lines are extended so that they meet at vertices on both ends of the line parallel to the mandible edge 118. A line is drawn along a joining edge 98 of the filter cutting template 56 and extending out to a point where it would meet and form an apex with the line parallel to the trans-maxilla edge 168 of the filter cutting template 56 and the line parallel to the trans-maxilla edge 168 is extended to meet it.

The line that will separate the mandible polyurethane foam member template 124 from the trans-maxilla polyurethane foam member template 170 can be derived in different ways.

The line drawn along the mandible edge 118 of the filter cutting template 56 is extended to meet the lines parallel to the trans-maxilla edge 168. Alternately the lines drawn along the trans-maxilla edges 168 of the filter cutting template 56 are extended to meet the line parallel to the mandible edge 118. Alternately taking the line extensions of the two previous alternatives of the meetings of the mandible polyurethane foam member template 124 and the trans-maxilla polyurethane foam member template 170 as limits a separation line can be drawn starting from the vertex of the trans-maxilla edges 168 and the mandible edge 118 of the filter cutting template 56 to any point along the parallel lines between the limits. These lines should be mirror images on either end of the resulting mandible polyurethane foam member template 124. The lines described will produce the shape and size of the mandible polyurethane foam member template 124 and two trans-maxilla polyurethane foam member templates 170. Only one trans-maxilla polyurethane foam member template 170 will be needed. Together these will be referred to as the polyurethane foam member templates 148.

Commercially available fiberboard or equivalent and commercially available high temperature nonstick tape are used to make the face gasket pre-form jig 50. A different face gasket pre-form jig 50 is needed for each different size of respiration filtering mask 158.

The shape and size of the face gasket pre-form jig 50 is derived with the use of the filter cutting template 56 for the size respiration filtering mask 158 being constructed. Using the filter cutting template 56 as a guide, lines are drawn parallel to the trans-maxilla edges 168 and the mandible edge 118 of the filter cutting template 56 0.75 inches (19 millimeters) (the width of the polyurethane foam strip 152) away from the edges of the filter cutting template 56. These parallel lines are extended so that they meet at vertices on both ends of the line parallel to the mandible edge 118. The lines parallel to the trans-maxilla edges 168 are extended in the direction opposite from the vertices approximately 3 inches (76 millimeters). A line connects the two end points of the lines parallel to the trans-maxilla edges 168. This produces a 4 sided shape.

This shape is transferred to the fiberboard or equivalent of a thickness roughly equivalent to the thickness of the polyurethane foam member and the fiberboard or equivalent is cut along these lines. A Permanent release agent or high temperature nonstick tape is applied to both faces of the cut fiberboard or equivalent along the three cut edges determined by the three parallel lines, to a line approximately 2 inch distant in from each of the three edges. The resulting tool will be referred to as the face gasket pre-form jig 50.

A layer of commercially available elastic knit cloth 38 that is comfortable in long term contact with the skin such as a double brushed, 85% polyester—15% polyether-polyurea copolymer knit cloth or equivalent is laminated on one side to a commercially available thin film, flexible, stretchable, and fusible web 162 such as polyethylene stretch wrap film or equivalent using a heat press with the appropriate heat, pressure, and time to laminate the thin film, flexible, stretchable, and fusible web 162 to the elastic knit cloth 38. Strips are cut from this laminate material, approximately 2.5 inches (63 millimeters) wide and a length determined by the size of the mask being constructed. The resulting part will be referred to as the face gasket outer cover strip 48.

A web of commercially available knit, woven, or nonwoven material 102 is laminated on one side to a web of commercially available fusible sheet 82 in the heat press with the appropriate heat, pressure, and time to laminate the fusible sheet 82 to the knit, woven, or nonwoven material 102. The resulting part will be referred to as the laminated fusion strip material 106.

A commercially available paper card stock is used to make a fog shield cutting template 72. A different fog shield cutting template 72 is needed for each different size of respiration filtering mask 158. The fog shield cutting template 72 is shaped and sized to fill an area on the folded and fused flat assembly 76 demarked by lines that follow the edge of the mask filter 126 from one of the cheek sealing chevrons 24 to the nose bridge chevron overlap 138 of the face gasket 42 and then to the other cheek sealing chevron 24, and along the fold edge of the folded and fused flat assembly 76 from each cheek sealing chevron 24 to a point where the outer fold of the outer concentric pleat 140 will be in the final construction of the respiration filtering mask 158 and along a line between these two points. Two of the parts of the fog shield cutting template 72 and the resulting fog shield 68 will be called the fog shield nose chevron 74 and the fog shield cheek chevrons 70. The resulting tool will be referred to as the fog shield cutting template 72.

A web of commercially available fusible open mesh 80 is layered against both faces of a web of the filter strip 62 and placed in the heat press. The heat press is engaged with the appropriate heat, pressure, and time to laminate the fusible open mesh 80 to the filter strip 62. The resulting part will be referred to as the filter laminate element 60.

The laminated fusion strip material 106 is cut into 0.5 inch (13 millimeter) wide strips. The resulting part will be referred to as the laminated fusion strips 108.

The laminated fusion strips 108 are cut to the length of the joining edges 98 of the size mask being constructed. The resulting part will be referred to as the joining-edge fusion strips 100.

Four harness strap fusion strips 88 are positioned, one on each face of each end of each harness strap 90 so that each end of each harness strap 90 is sandwiched between two harness strap fusion strips 88 across the width of the end of the harness strap 90 to a depth of the width of the harness strap fusion strips 88. With the harness strap fusion strips 88 temporarily held in position the ends of the harness straps 90 are put into the heat press and the heat press 92 is engaged with the appropriate heat, pressure, and time to laminate the harness strap fusion strips 88 to both sides of the ends of the harness straps 90. At the end of the heat press 92 cycle the harness straps 90 with the laminated harness strap fusion strips 88 are removed from the heat press 92 and allowed to cool. When cooled the excess harness strap fusion strip 88 that may have extruded or extend beyond the edges of the harness strap 90 is trimmed off.

A push rod made of a stiff wire with a small enough diameter to fit through the hole of the cord lock mechanism 34 is used to push the harness strap 90 material through the cord lock mechanism 34. One of the ends of the push rod is placed against in the length and width middle of the harness strap 90 and the material is draped over the push rod end. With the cord lock mechanism 34 pushed into the open position the end of the push rod with the harness strap 90 material draped over it is pushed through the hole of the cord lock mechanism 34 far enough for the harness strap 90 material to be grasped and held while the push rod is removed from the cord lock mechanism 34. Enough harness strap 90 material is then pulled through the cord lock mechanism 34 to allow the installation of the removal obstruction 156.

The removal obstruction 156 is installed on a harness strap 90 by folding the harness strap 90 in the middle of its length and placing the removal obstruction 156 in the fold. The fold of the harness strap 90 with the removal obstruction 156 held in place in the fold is places in the heat press 92 and the heat press 92 is engaged with the appropriate heat, pressure, and time to fuse the removal obstruction 156 to the harness strap 90. The resulting assemblies will be referred to as the harness straps 90.

The malleable strip 116 is cut to a length of approximately 35 millimeters (1.5 inch). The resulting parts will be referred to as the trans-maxilla curve holders 166.

The mandible polyurethane foam member template 124 will be used to make one mandible polyurethane foam member 122, and the trans-maxilla polyurethane foam member template 170 will be used to make two trans-maxilla polyurethane foam members 172 for each respiration filtering mask 158.

The polyurethane foam member templates 148 are used to trace lines on the polyurethane foam strips 152 and the polyurethane foam strips 152 are cut along these lines. The resulting parts will be referred to as the polyurethane foam members 150.

The face gasket pre-form jig 50 of the appropriate size and shape for the size of respiration filtering mask 158 being constructed is used to shape the face gasket outer cover strip 48 into the face gasket outer cover 46.

The face gasket outer cover strip 48 is folded in half with the fold parallel with the long edge of the face gasket outer cover strip 48 so that the thin film, flexible, and stretchable and fusible web 162 layer of the laminate is facing itself.

The face gasket pre-form jig 50 is placed within this fold with the gasket mandible forming edge 84 against the fold and the middle of the gasket mandible forming edge located 84 at the lengthwise middle of the face gasket outer cover strip 48.

One or more low-profile clips 114 are placed over the face gasket outer cover strip 48 pinching it to the gasket mandible forming edge 84 of the face gasket pre-form jig 50.

The parts of the folded face gasket outer cover strip 48 that extend past the ends of the gasket mandible forming edge 84 of the face gasket pre-form jig 50 are moved so that the two gasket trans-maxilla-forming 86 edges of the face gasket pre-form jig 50 are within the fold and pressed against the fold.

Low-profile clips 114 are placed over the face gasket outer cover strip 48 pinching it to two gasket trans-maxilla-forming 86 edges of the face gasket pre-form jig 50.

All the Low-profile clips 114 are placed to pinch the face gasket outer cover strip 48 to the face gasket pre-form jig 50 edges in the approximately the middle of the length of the face gasket pre-form jig 50 edges.

This produces a pucker of the face gasket outer cover strip 48 as it bends around the corners formed at the vertex of the gasket trans-maxilla-forming edges 86 and the gasket mandible forming edge 84 of the face gasket pre-form jig 50.

Each of the four puckers is cut so that there is a slit running from about the middle of the outer length of the pucker to a point on the plain of the face of the face gasket pre-form jig 50 that meets the vertex of the gasket mandible forming edge 84 and a gasket trans-maxilla-forming edge 86.

The slits in the pucker of the face gasket outer cover strip 48 on opposite faces of the face gasket pre-form jig 50 do not meet but leave a connecting web of the face gasket outer cover strip 48 approximately the thickness of the face gasket pre-form jig 50 connecting the face gasket outer cover strip 48 along the gasket mandible forming edge 84 and the gasket trans-maxilla-forming edges 86.

These four slits in the four puckers allow the material of these former puckers to lie flat against the two faces of the face gasket pre-form jig 50 with parts of the face gasket outer cover strip 48 overlapping each other.

The face gasket pre-form jig 50 with the face gasket outer cover strip 48 clipped in position around the gasket mandible forming edge 84 and the gasket trans-maxilla-forming edges 86 is placed in the heat press 92 and the heat press 92 is engaged with the appropriate heat, pressure, and time to cause the overlapped parts of the face gasket outer cover strip 48 to laminate to each other.

At the end of the cycle the face gasket pre-form jig 50 is flipped over to expose the other face to the heating element of the heat press 92 and the process is repeated.

At the end of the cycle the face gasket pre-form jig 50 with the face gasket outer cover strip 48 is removed and allowed to cool.

After cooling the face gasket outer cover strip 48 is removed from the face gasket pre-form jig 50 and becomes the face gasket outer cover 46.

The resulting shape of this face gasket outer cover 46 is of three exaggerated “u” shapes forming deep pockets meeting each other at an angle equal to that of the mask filter 126 that it is to be joined with at the vertex of the mandible edge 118 and the trans-maxilla edge 168.

These pockets will be referred to as the mandible pocket 120 along the mandible edge 118 and the trans-maxilla pockets 178 along the trans-maxilla edges 168 of the face gasket 42. The two vertices formed between the mandible edge 118 and the two trans-maxilla edges 168 in the face gasket outer cover will be referred to as the cheek sealing chevrons 24. The resulting part will be referred to as the face gasket outer cover 46.

A length of laminated fusion strip 108 is cut approximately 30 millimeters (1 inch) long producing a point seal 146 that is approximately 15 millimeters (0.5 inch) by 30 millimeters (1 inch). The resulting part will be referred to as the point seal 146.

A fog shield cutting template 72 appropriate for the size respiration filtering mask 158 being constructed is placed on a sheet of the laminated fusion strip material 106 and a tracing is made of the edges of the fog shield cutting template 72 onto the laminated fusion strip 106 material. The laminated fusion strip material 106 is cut along the tracing lines to make the fog shield 68. The resulting part will be referred to as the fog shield 68.

One or more filter laminate element(s) 60 and one or more copper cloth filter laminate element(s) 30 are alternately stacked against each other, and this stack of laminate elements 104 is placed in the heat press 92 and the heat press 92 is engaged with the appropriate heat, pressure, and time to cause the fusible open mesh 80 laminated to the separate laminate element 104 surfaces to fuse. The resulting part will be referred to as the filter laminate 58.

The filter cutting template 56 for the particular size respiration filtering mask 158 being constructed is chosen and laid on the filter laminate 58. A tracing of the filter cutting template 56 is made on the filter laminate 58 around the edge of the filter cutting template 56. The filter laminate 58 is cut along the filter cutting template 56 traced lines to make the flat mask filter 126.

The mandible edge 118, the two trans-maxilla edges 168, and the two joining-edges 98 of the mask filter 126 will be covered for the length of the entire edge by the edge fusion strips 36.

The edge fusion strips 36 are cut to the lengths of the edges of the cut mask filter 126 to be covered. The cut to length edge fusion strips 36 are placed on the edges of the cut mask filter 126 with the edges of the cut mask filter 126 within and to the edge of the fold. The low-profile clips 114 are placed to pinch the edge fusion strips 36 to the edges of the cut mask filter 126 and hold them in place.

193 The cut mask filter 126 with the attached edge fusion strips 36 and low-profile clips 114 is placed into the heat press. The heat press 92 is engaged with the appropriate heat, pressure, and time to laminate the edge fusion strips 36 to both the outside face 142 and the inside face 96 of the mask filter 126.
194 When the mask filter 126 is cool enough, the low-profile clips 114 are removed. Excess edge fusion strip 36 material that has extruded beyond the original edge of the mask filter 126 is trimmed off. The resulting part will be referred to as the mask filter 126.

Two joining-edge fusion strips 100 are attached to each mask filter 96 one fused to the joining-edge 98 of the outside face of the mask filter 126 and one fused to the joining-edge 98 of the inside face of the mask filter 96.

To assemble and fuse a joining-edge fusion strip 100 to each of the faces of the mask filter 96, a joining-edge fusion strip 100 is places with its long edge parallel to the joining-edge 98 of the mask filter 96, with half the width of the fusible sheet side of the joining-edge fusion strip 100 in contact with the entire length of the edge fusion strip 36 on the joining-edge 98 of the mask filter 96.

197 The mask filter 96, with the joining-edge fusion strips 100 temporarily held in position, is placed in the heat press 92 and the heat press 92 is engaged with the appropriate heat, pressure, and time to fuse the fusible sheet side of the joining-edge fusion strips 100 to the edge fusion strips 36 of the mask-filter 96 joining-edges 98. The resulting part will be referred to as the mask filter edge fusion strip sub-assembly 130.

The ends of one upper and one lower harness strap 90 will be attached to the outside face of the mask filter edge fusion strip sub-assembly 130.

On the outside face 142 of the mask filter 126 measurements are made and marked for the placing of the ends of the one upper and one lower harness strap.

200 The exact placement of the ends of the harness strap 90 on the edge of the mask filter 96 well very with different size respiration filtering mask 158 being made.

To mark the right and left side the mask filter 96 for the placement of the lower harness strap 90, a point along the mandible edge 118 of the mask filter 96 is found approximately 25 millimeters (1 inch) from the vertex of the mandible edge 118 and the trans-maxilla edge 168. From this point a line perpendicular to the mandible edge 118 is drawn the length of the edge fusion strip 36. Another line is drawn parallel to the first and the same length of the first starting at the mandible edge 118 and at a distance from the first line equal to the width of the harness strap 90 on the opposite side of the first line as the mandible edge 118 and trans-maxilla edge 168 vertex.

The harness strap fusion strips 88 of the lower harness strap 90 are placed one between the right perpendicular line and the right parallel line and one between the left perpendicular line and the left parallel line. The long edge of each of the harness strap fusion strips 88 are positioned against the edge of the mandible edge 118 of the mask filter 96 so that the end of the harness strap 90 is located at the edge of the mask filter 96. The harness strap fusion strips 88 are temporarily secured in this position.

To mark the right and left side of the mask filter 96 for the placement of the upper harness strap 90, a point along each trans-maxilla edge of the mask filter 96 is found approximately 25 millimeters (1 inch) from the vertex of the mandible edge 118 and the trans-maxilla edge 168. From this point a line perpendicular to the trans-maxilla edge 168 is drawn the length of the edge fusion strip 36. Another line is drawn parallel to the first and the same length of the first, starting at the trans-maxilla edge 168 and at a distance from the first line equal to the width of the harness strap 90 on the opposite side of the first line as the mandible edge 118 and trans-maxilla edge 168 vertex.

The harness strap fusion strips 88 of the upper harness strap 90 are placed one between the perpendicular line and the parallel line on the right trans-maxilla edge 168 and one between the perpendicular line and the parallel line of the left trans-maxilla edge 168 with the long edge of each of the harness strap fusion strips 88 along the edge of each trans-maxilla edge 168 of the mask filter 96 so that the end of the harness strap 90 is located at the edge of the mask filter 96. The harness strap fusion strips 88 are temporarily secured in this position.

The mask filter 96 with the harness strap fusion strips 88 held in position is put in the heat press 92. The heat press 92 is engaged with the appropriate heat, pressure, and time to fuse the laminated harness strap fusion strips 88 on the ends of the harness strap 90 with the edge fusion strips 36 around the periphery of the mask filter 96. At the end of the heat press 92 cycle the mask filter and harness strap assembly 128 is removed and allowed to cool. After cooling the harness strap 90 fusion area is trimmed to the edge of the mask filter 96. The resulting part will be referred to as the mask filter and harness strap assembly 128.

The mandible polyurethane foam member 122 is placed into the mandible pocket 120 of the face gasket outer cover 46 with the edge of the mandible polyurethane foam member against the folded edge of the mandible pocket 120 oriented so that it will meet the trans-maxilla polyurethane foam members 172 with no gaps, and they will completely fill the vertex at the cheek sealing chevron 24 of the face gasket 42.

The two trans-maxilla polyurethane foam members 172 are placed into the trans-maxilla pockets 178 of the face gasket outer cover 46 with the edges of the trans-maxilla polyurethane foam members 172 against the folded edges of the trans-maxilla pockets 178 oriented so that they will meet the mandible polyurethane foam member 122 with no gap, and they will completely fill the vertex at the cheek sealing chevron 24 of the face gasket 42.

The face gasket outer cover 46 with the two trans-maxilla polyurethane foam members 172 and one mandible polyurethane foam member 122 installed, now has approximately 10 mm (0.4 inches) of face gasket outer cover 46 extending beyond the edge of the polyurethane foam members 150 opposite the fold edge of the face gasket outer cover 46 above and below the polyurethane foam members 150. The mask filter and harness strap assembly 128 is placed between these extending edges of the face gasket outer cover 46 such that the mandible edge 118 of the mask filter and harness strap assembly 128 is pressed against the mandible polyurethane foam member 122 and the trans-maxilla edges 168 of the mask filter and harness strap assembly 128 are pressed against the trans-maxilla polyurethane foam members 172, with the harness straps 90 facing up.

One trans-maxilla curve holder 166 is placed between the surface that will face the outside of the finished restoration filtering mask 158 of each of the trans-maxilla polyurethane foam members 172 and the face gasket outer cover 46.

210 The trans-maxilla curve holders 166 are positioned in the approximate middle of the width of each of the trans-maxilla polyurethane foam members 172 with the long edges of the trans-maxilla curve holders 166 parallel to the long edges of the trans-maxilla polyurethane foam members 172. The short edge of each of the trans-maxilla curve holders 166 facing the opposite direction from the cheek sealing chevron 24 is positioned approximately 10 mm from the nearest short edge of the trans-maxilla polyurethane foam member 172. The trans-maxilla curve holders 166 are temporarily secured in place to prevent movement.

The face gasket outer cover 46 with the three polyurethane foam members 150 and the two trans-maxilla curve holders 166 installed is temporarily secured to the mask filter and harness strap assembly 128 to hold them in place during the trimming and laminating process.

The joining-edge fusion strips 100 fused, one to the inside face and one to the outside face 142 of the mask filter and harness strap assembly 128 are now partially covered by a portion of the face gasket outer cover 46. The portion of the face gasket outer cover 46 covering the fusible side of the joining-edge fusion strips 100 is cut away on both the inside face 96 and the outside face 142 of the mask filter and harness strap assembly 128.

The mask filter and harness strap assembly 128 with the face gasket assembly temporarily secured in position, is placed in the heat press 92. The heat press 92 is engaged with the appropriate heat, pressure, and time to fuse the face gasket outer cover 46 to the edge fusion strips 36 of the mandible edge 118 and the two trans-maxilla edges 168 of the mask filter and harness strap assembly 128. At the end of the heat press 92 cycle the mask filter and harness strap assembly 128 with the face gasket assembly is turned over and the heat press 92 is engaged with the appropriate heat, pressure, and time to fuse the face gasket outer cover 46 to the edge fusion strips 36 of the mandible edge 118 and the two trans-maxilla edges 168 of the mask filter and harness strap assembly 128. At the end of the heat press 92 cycle the mask filter and harness strap assembly 128 with the face gasket assembly is removed and allowed to cool. The resulting part will be referred to as the flat assembly 64.

The flat assembly 64 is folded along two lines, the right fold line 160 and the left fold line 110, so that the inside face 96 is folded against itself.

The right fold line 160 runs from a point at the right vertex of the mandible edge 118 and the trans-maxilla edge 168 of the mask filter 126 to a point approximately one third across the length of and on the right side of the cone-point-edge 28 of the mask filter 126.

The left fold line 110 runs from a point at the left vertex of the mandible edge 168 and the trans-maxilla edge 168 of the mask filter 126 to a point approximately one third across the length of and on the left side of the cone-point-edge 28 of the mask filter 126.

The position of these fold lines is such that when folded flat the fusible side of the joining-edge fusion strip 100 attached to the inside face 96 of the flat assembly 64 will come in overlapping contact with the edge fusion strip 36 of the other inside face 96 joining edge 98 of the flat assembly 64, and the fusible side of the joining-edge fusion strip 100 attached to the outside face 142 of the flat assembly 64 will come in overlapping contact with the edge fusion strip 36 of the other outside face 142 joining edge 98 of the flat assembly 98.

A triangle of release agent sheet is placed into the pocket formed by the folding of the flat assembly 64 to keep the inside face 96 surfaces from fusing to each other. The flat assembly 64 is held in this folded position and placed into the heat press 92, and the heat press 92 is engaged with the appropriate heat, pressure, and time to fuse the joining-edge fusion strips 100 to the edge fusion strips 36 on the joining edges 98 of the respiration filtering mask 158, forming the mask fusion seam 134 of the folded and fused flat assembly 76 of the respiration filtering mask 158.

Approximately 15 mm of the 30 mm length of the point seal 146 is laid on the mask fusion seam 134 side of the folded and fused flat assembly 76 with the fusible side of the point seal 146 laminate in contact with the mask fusion seam 134. The point seal 146 is positioned so that 15 mm of the 30 mm length extends past the point of the folded and fused flat assembly 76. The point seal 146 is held in this position on the folded and fused flat assembly 76 and they are placed in the heat press 92. The heat press 92 is engaged with the appropriate heat, pressure, and time to fuse the point seal 146 to the mask fusion seam 134 of the folded and fused flat assembly 76. At the end of the heat press 92 cycle the folded and fused flat assembly 76 is flipped over and the portion of the point seal 146 that is extending past the point of the folded and fused flat assembly 76 is folded over the point of the folded and fused flat assembly 76 and brought into contact with the mask filter 126 on the opposite face of the folded and fused flat assembly 76 from the mask fusion seam 134 face. The point seal 146 is held in the folded position and the heat press 92 is engaged with the appropriate heat, pressure, and time to fuse the point seal 146 to the mask filter 126 of the folded and fused flat assembly 76.

The fog shield 68 is placed on the mask filter 126 of the folded and fused flat assembly 76 over the mask fusion seam 134 with the fusible side of the fog shield 68 laminate in contact with the surface of the mask filter 126.

The fog shield 68 is positioned so that the fog shield nose chevron 74 is placed just under the nose bridge chevron overlap 138 of the face gasket 42 and the two fog shield cheek chevrons 70 are placed just under the cheek sealing chevrons 24 of the face gasket 42 with the edge of the lines between the fog shield nose chevron 74 and the fog shield cheek chevrons 70 in contact with or over lapping the area where the face gasket 42 is fused with the folded and fused flat assembly 76.

The fog shield 68 is held in place on the folded and fused flat assembly 76 and they are put into the heat press 92, and the heat press 92 is engaged with the appropriate heat, pressure, and time to fuse the fog shield 68 to the folded and fused flat assembly 76. The resulting part will be referred to as the flat respiration filtering mask 66.

The flat respiration filtering mask 66 is shaped into the final cup shape of the respiration filtering mask 158 by removing the triangle of release agent sheet from the two inner faces of flat respiration filtering mask 66 and pulling these two inner faces away from each other forming the flat respiration filtering mask 66 into a cone. With appropriate tools concentric pleat folds are installed in the mask filter 126 cone, shortening the distance of the point of the cone from the base of the cone. This makes and holds the cup shape of the respiration filtering mask 158. The resulting part will be referred to as the respiration filtering face mask 158.

It should be understood that the examples and embodiments described herein are for illustrative purposes only and that various modifications or changes in light thereof will be suggested to persons skilled in the art and are to be included within the spirit and purview of this invention as defined in the appended claims. This invention may take on various modifications and alterations without departing from its spirit and scope. Accordingly, this invention is not to be limited to the above described but is to be controlled by the limitations set forth in the following claims and any equivalents thereof. This invention may also be suitably practiced in the absence of any element not specifically disclosed herein.

What is claimed is:

1. A fluid filtering web composed of at least one layer of a mechanical particle filtering web and at least one layer of a web of a woven or non-woven cloth comprised of fibers or threads of a metal or a metallic alloy containing copper or silver as one of the alloy constituents. These layers laminated together in a way that will not significantly impede the flow of the fluid.

2. The fluid filtering web of claim 1, wherein the lamination between the web layers is achieved by means of a web of a thermo plastic thermally bonded to the two adjoining webs.

3. The fluid filtering web of claim 1, wherein the lamination between the web layers is achieved by means of a web of a thermo plastic Ultrasonically bonded to the two adjoining webs.

4. The fluid filtering web of claim 1, wherein the lamination between the web layers is achieved by means of a web of adhesive bonding to the two adjoining webs.

5. The fluid filtering web of claim 1, wherein the lamination between the web layers is achieved by means of placement of a pattern of short lines of a thermoplastic melt between two adjoining webs and pressing the webs together.

6. The fluid filtering web of claim 1, wherein the lamination between the web layers is achieved by means of placement of a pattern of short lines of a thermoplastic melt on one web element and joining that web element to the adjoining web element by ultrasonic welding.

7. The fluid filtering web of claim 1, wherein the lamination between the web layers is achieved by means of placement of a pattern of short lines of an adhesive.

8. The fluid filtering web of claim 1, pleated, folded, or shaped and attached to a frame to form a filter cartridge suitable for environmental air handling and HVAC systems and equipment.

9. The fluid filtering web of claim 1, cut to the size and shape for use in respiration filtering masks that use replaceable filters.

10. The fluid filtering web of claim 1, cut, shaped, and framed to form cartridges for use in respiration filtering masks that use replaceable filter cartridges.

11. The fluid filtering web of claim 1, wherein the two outer layers of the fluid filtering web are of the said web of a woven or non-woven cloth comprised of fibers or threads of a metal or a metallic alloy containing copper or silver as one of the alloy constituents, and are connected mechanically so that they share the same electric charge.

12. The fluid filtering web of claim 1, cut to a shape that will allow the flat filter to form a cone when two of the said shapes edges are brought together.

13. The filter shape of claim 12, wherein a filter cone is formed by affixing two edges together.

14. The filter cone of claim 13, wherein the two edges affixed to form the cone are affixed by means of fused thermoplastic layer.

15. The filter cone of claim 13, wherein the two edges affixed to form the cone are affixed by means of adhesive.

16. The filter cone of claim 13, wherein the two edges affixed to form the cone are affixed by means of one or more bridging members of fused thermoplastic.

17. The filter cone of claim 13, wherein the two edges affixed to form the cone are affixed by means of one or more bridging members of fused thermoplastic, said thermoplastic also fused to a woven, knit, or non-woven backing material.

18. The fluid filtering web of claim 1, cut to a shape that will allow the flat filter to form a cone when two of the said shapes edges are brought together, wherein the periphery of said cone will form two chevrons approximately 180 degrees from each other on the said periphery of said cone the apexes of said chevrons pointing away from the apex of the said cone.

19. The fluid filtering web of claim 1, cut to a shape that will allow the flat filter to form a cone when two of the said shapes edges are brought together, wherein the periphery of said cone will form two chevrons approximately 180 degrees from each other on the said periphery of said cone, the apexes of said chevrons pointing away from the apex of the said cone, and a third chevron is formed midway between the said two chevrons approximately 180 degrees from each other on the said periphery of said cone, said third chevron's apex pointing in the direction towards the apex of the cone.

20. The filter shape of claim 19, wherein a filter cone is formed by affixing two edges together.

21. The filter cone of claim 20, wherein the two edges affixed to form the cone are affixed by means of a fused thermoplastic layer.

22. The filter cone of claim 20, wherein the two edges affixed to form the cone are affixed by means of adhesive.

23. The filter cone of claim 20, wherein the two edges affixed to form the cone are affixed by means of one or more bridging members of fused thermoplastic.

24. The filter cone of claim 20, wherein the two edges affixed to form the cone are affixed by means of one or more bridging members of fused thermoplastic, said thermoplastic also fused to a woven, knit, or non-woven backing material.

25. The filter cone of claim 20, shortened in length between the said periphery of the cone and the said apex of the cone by means of circular, concentric pleats radiating from the said apex of the cone.

26. The shortened filter cone of claim 25, wherein the entire periphery of the cone is affixed to a flexible gasket of a material such as a polyether-polyurea copolymer or other flexible material that is comfortable when in intimate contact with the skin that will be in intimate contact with the face when the combined shortened filter cone of claim 25 and the gasket are worn as a respiration filtering face mask.

27. A respiration filtering face mask comprised of the shortened filter cone and periphery flexible gasket of claim 26 and attached head straps.

28. The respiration filtering face mask of claim 27, wherein the flexible gasket is comprised of two outer layers of a material comfortable when in intimate contact with the skin and an intervening padding layer.

29. The respiration filtering face mask of claim 27, wherein the flexible gasket is comprised of two outer layers of a material such as a polyether-polyurea copolymer or other flexible material that comfortable when in intimate contact with the skin that have been made resistant to air passage through the material by means of laminating one side of the outer layer material with a thin plastic or other coating resistant to air flow.

30. The respiration filtering face mask of claim 27, wherein the flexible gasket material extends beyond the extent of the periphery of the said shortened filter cone past the said affixed edges of the said filter cone wherein the extended flexible gasket material overlaps itself at the said third chevron's apex.

31. The respiration filtering face mask of claim 27, wherein the head straps and the flexible gasket are affixed to the said shortened filter cone by means of a fused thermoplastic layer.

32. The respiration filtering face mask of claim 27, wherein the head straps and the flexible gasket are affixed to the said shortened filter cone by means of an adhesive.

33. The respiration filtering face mask of claim 27, wherein the said padding in between the said outer layers of the flexible gasket dose not extend past the affixed edges of the filter cone wherein the extended flexible gasket material overlaps itself at the said third chevron's apex without the intervening padding layer.

34. The respiration filtering face mask of claim 27, wherein the flexible gasket has two trans-maxilla curve holders made of a material that is bendable by hand but stiff to lesser forces, on either side of the said third chevron.

35. The respiration filtering face mask of claim 27, wherein the head straps are made of a wide strip of a polyether-polyurea copolymer or other elastic cloth that is comfortable to the skin.

36. The respiration filtering face mask of claim 27, wherein the apex of the said filter cone is sealed against the passage of air.
